(19) United States
(12) Patent Application Publication
(10) Pub. No.: US 2008/0060943 A1
(43) Pub. Date: Mar. 13, 2008

(54) DEVICE AND METHOD FOR THE TREATMENT OF DRINKING WATER

(76) Inventor: Rolf Zimmermann, Lautenbach (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/851,672

(22) Filed: Sep. 7, 2007

(30) Foreign Application Priority Data
Sep. 8, 2006 (DE) 10 2006 042 804.8

(51) Int. Cl. C02F 1/461

(52) U.S. Cl. 204/556; 204/663

(57) ABSTRACT

According to a method and device, enriched drinking water is provided in which reduced ionized basic water is produced by means of an electrolysis unit. A probiotic fluid, liquid minerals, or liquid trace elements as well as gaseous and/or stabilized oxygen may be added to the reduced ionized basic water so that drinking water with special electrochemical properties is produced. In a simple manner, the method and the devices permit the production of biologically effective varieties of drinking water that make it possible to provide a person with large amounts of antioxidants and to adjust the pH balance, to maintain the oxidation-reduction balance, and to be able to cause a reduction of intestinal putrefaction through milieu changes in order to maintain or restore the balance of a person's basic prevention.

### CROSS-REFERENCE TO RELATED APPLICATION

The present application claims priority under 35 U.S.C. §119 to German Patent Application No. 10 2006 042 804.8, filed on Sep. 8, 2006, the entire disclosure of which is incorporated herein by reference.

### TECHNICAL FIELD OF THE INVENTION

This invention concerns a process for the treatment of drinking water and a method for dispensing it into a container.

### DESCRIPTION OF THE RELATED ART

Frequently, health therapies for people are not successful or are only partially successful because the sick people are not capable of correctly metabolizing the prescribed nutrient supplements, plant-based restoratives, or medications. When the human organism is incapable of metabolizing these agents, it does not come as a surprise that there are already studies that indicate that nutrient supplements might be carcinogenic. Other studies show that people who eat a lot of fast food and then take vitamin pills as supplements are totally incapable of metabolizing these pills. As a consequence, they produce a very expensive urine because they are very dehydrated and their pH status is completely out of balance.

Recently, a simple and inexpensive diagnostic method was developed wherein a mere urinalysis allows conclusions regarding the dehydration, the pH balance, the intestinal putrefaction, and the status of the immune system of the person in question. Here, the dehydration is determined by the conductivity of the morning urine, the intestinal putrefaction by means of a titration and precipitation process with a calibrated color scale, and the status of the immune system by means of the redox potential. For the pH balance, the pH value is determined 5 times a day for 2 days, and the pH value of the morning urine is determined on the third day.

Here, the conductivity shows whether a body is dehydrated, i.e. has a water deficiency. The conductivity of the urine allows conclusions regarding whether the patient drinks enough free water. Free water here means tap water without carbonation. It is known that without enough water, vital body functions cannot proceed in optimal fashion which means that waste cannot be removed from the body in sufficient quantities. Also, the pH balance can only be regulated if the body is no longer dehydrated.

Determining the pH value of the urine shows whether the body is hyperacidic in the extracellular or also in the intracellular region. When the body is hyperacidic, the mineral reserves of the body are used up which is known to cause a multitude of physical problems. Depending on the course of the examinations, it may be found that only a hyperacidity of the tissue, possibly also an intracellular acidosis (impairment of the buffer capacity in the blood), a latent hyperacidity with a tendency for hyperacidity of the tissue, or an alkalosis or a hidden intracellular acidosis may be present.

The more putrefaction is produced during human digestion, the more toxic substances are generated that may enter the blood circulation. Since intestinal putrefaction is caused by a change of the intestinal milieu, accompanied by an increased activity of putrefactive bacteria producing boron, phosphorus, and hydrogen sulfide compounds, these toxic compounds are easily absorbed by the intestinal wall and will then reach the blood system and the urine. This is why intestinal putrefaction can be determined from the urine. The toxic metabolic products generated by intestinal putrefaction are also absorbed by the blood so that, besides carrying a toxic load, the flowability of the blood, and therefore ultimately the heart, are negatively affected. Over time, this has the effect that all organs, muscles, and cells are gradually loaded with toxic substances because, due to its viscosity, the blood can no longer provide an optimal supply of oxygen to the body. The consequence is an increasing oxygen deficiency throughout the body.

The redox potential provides information on the electron flow during elimination. Every living organism is subject to the interaction between oxidation and reduction. This means that an oxidation leads simultaneously to a reduction, and vice versa. This interaction can be determined by means of the redox potential or redox value (mV), and this value is directly related to the condition of the immune system, showing the milieu status. The further this value deviates from those of a healthy person (approximately +50 to +100 mV), the more acute the illness and the imbalance of the body milieu.

These examinations therefore permit reliable conclusions regarding the momentary status (actual status) of the physical condition and, building on that, allow step-by-step recommendations for a person to improve his or her own physical condition, starting specifically with dehydration.

Portable beverage machines for private homes or commercial establishments are known that provide treated drinking water for dispensing into drinking containers. The devices have a housing that holds a water treatment device, an operating unit, a control unit, and a drinking water dispenser. Electrolytic water treatment devices for the treatment of tap water are known that generate ionized basic or ionized acidic water by means of an electrolysis chamber. This water is recommended for hyperacidity, with the only emphasis on a high pH value that exceeds 8.

### SUMMARY OF THE INVENTION

This invention addresses the problem of proposing a device and a method for producing treated drinking water that may be used for eliminating various dysfunctional conditions in the basic prevention of the human body.

According to the invention, the problem is solved by a device and a method as defined in the Claims. Additional advantageous implementations can be found in the relevant subclaims.

According to the invention, the water treatment device comprises an electrolysis unit that separates water supplied under pressure into anions and cations and produces acidic and basic water. The control unit releases the dispensing of basic water to the user only after a build-up time of at least 20 seconds. This release may be accomplished simply acoustically or via a valve, but is accomplished preferably in conjunction with a voice unit that gives instructions and information to the user regarding, for example, the condition of the device, of the use of additives, and of service malfunction messages, and issues one motivational sentence per drinking cup. After said build-up time, reduced ionized drinking water is available to the user that has a significantly lower redox potential than the water supplied initially. Commonly, this reduced ionized basic water has a redox potential of less than −50 mV. Consequently, this drinking water is a strong antioxidant capable of reducing the free radicals and the above-mentioned and possibly very large imbalance in the oxidation redox potentials that may exist in a sick person.

According to a further implementation of the invention, the water treatment device comprises an oxygen enrichment unit that may be connected with the electrolysis unit and supplies it with oxygen-enriched water.

The oxygen enrichment unit may be implemented as a unit for supplying stabilized oxygen in liquid form and/or as a unit for introducing gaseous oxygen. As discussed below with other additives, the introduction of stabilized oxygen in liquid form is accomplished by controlled removal by means of vacuum suction from a container. The addition of stabilized oxygen amounts to approximately 630 mg/liter. The oxygen content of the beverage enriched with gaseous oxygen in % or mg depends on the temperature.

In the oxygen enrichment unit, the gaseous oxygen is preferably attached to the water molecules without pressure in an enrichment chamber so that the source water with an oxygen content of commonly 90-100%, depending on the temperature, will afterwards have an oxygen content of 350% to 600-700% (corresponding to approximately 60 mg/Liter). The oxygen-enriched water is produced as follows: the water passes in a longitudinal direction through hollow fibers with micropores, and the oxygen surrounds these hollow fibers with standing water, passing through said pores at right angles to the flow direction without pressure, or almost without pressure. The volume of the enrichment chamber is larger than needed for the dispensing process. Due to the enrichment without pressure, the oxygen evaporates much less than in other known processes. Consequently, the oxygen in the oxygenated water is available much longer and is not aggressive inside the body because no free radicals are formed. Then, the oxygen-enriched water may, but does not have to be subjected to the electrolysis mentioned above, which may have the effect of turning it into an ionized reduced oxygenated water that is an oxidant and an antioxidant at the same time. The drinking water produced in this manner supports the body during oxidation and reduction. Therefore, by means of drinking water, the body is supplied with two components that have a positive influence on the condition of balance in the human body.

Both types of oxygen enrichment may be used alternatively or simultaneously, with or without ionization.

The device proposed by the invention may be designed with a capability for producing either one or several types of drinking water.

According to a further implementation of the device, the water treatment device may comprise devices for adding liquid additives to the dispensed drinking water. Preferably, such devices for adding liquid additives include a device for adding a probiotic liquid and/or liquid minerals and/or essential trace elements. According to the proposed process, these are injected into the fluid flowing into the container for holding the drinking water. The injection may be accomplished with various devices, preferably by means of a hose pump.

For cleaning and hygienization of the electrolysis unit, a device for introducing a cleaning agent is provided. Preferably, 30% citric acid is used as cleaning agent to prevent the unit from being clogged by calcium.

By adding a probiotic fluid, in particular a probiotic fluid commercially available under the trade name Darmfit™, the potential of the hydroxide ions (OH⁻) and the redox potential of the reduced ionized basic water are increased. Although the probiotic fluid is an indirect antioxidant and develops its antioxidizing properties only inside the body, and has itself a redox potential of more than 0 mV, it was found—surprisingly—that the addition of this probiotic fluid improves the electrochemical properties of the drinking water produced with its help, thereby further increasing the biological effect.

It is known that the change of the OH⁻ potential or of the redox potential in conjunction with the pH value of the drinking water has a strong influence on metabolism, the cleaning and the restoration of the intestine, and on achieving the balance of the metabolic processes in terms of the pH balance and the oxidation-reduction balance. The pH value of the reduced ionized basic water ranges from 8 to higher than 9. This value is also achieved after the addition of the probiotic fluid.

By adding liquid minerals or liquid trace elements, a treated drinking water is produced where the redox potential of the reduced ionized basic water is stabilized and the buffer capacity is increased by a multiple (more than 100 times). In addition, in one case, minerals are made available for the metabolic processes in the human body, and trace elements in the other. For adding liquid minerals, in particular the base colloid sold under the brand name OSIBA (OSIBA base concentrate) or the OSIBA trace element concentration with liquid essential trace elements like selenium, sulfur, boron, manganese, iron, iodine, chromium, copper etc. proved to be of value. Due to the addition of one or the other fluid, it was found—surprisingly—by means of buffer capacity measurements that the pH value of such a drinking water, compared with the reduced ionized basic water from the electrolysis chamber to which an acidic fluid (pH value 3.5) was added, remained almost constant (pH value approximately 8.6) over the same period of time while there was an extreme drop of the pH value of the reduced ionized basic water (pH value 5.5.)

### DESCRIPTION OF THE DRAWINGS

Below, the invention is explained in detail with the help of an embodiment in conjunction with the accompanying drawings; however, the invention is not restricted to the combinations selected for the individual implementations, but individual characteristics may also be implemented by themselves.

FIG. 1 shows the side view of a first device with an open side wall and a schematic view of the individual components;

FIG. 2 shows the wiring diagram for a device according to FIG. 1;

FIG. 3 shows a side view as in FIG. 1 of a different implementation;

FIG. 4 shows the wiring diagram for a device according to FIG. 3.

### DETAILED DESCRIPTION OF THE INVENTION

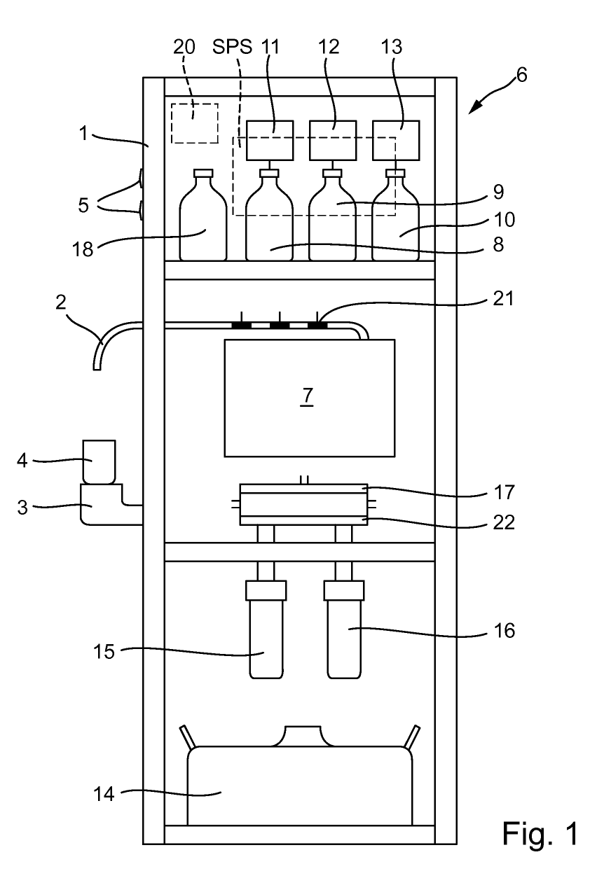

A drinking water outlet 2 and a drinking container holder 3, showing a cup 4 as an example, are located on the front side 1 shown in FIG. 1. Above the drinking water outlet 2, there are keys 5a to 5e (summarily designated as 5) that are only partially visible in this figure where 5a serves to start the operation and dispenses the reduced ionized basic water by itself without additives, while the other keys serve to select 4 additional and different drinking waters with additives: oxygenated water (5e), water with probiotic fluid (5b), water with liquid minerals (5c), water with liquid trace elements (5d).

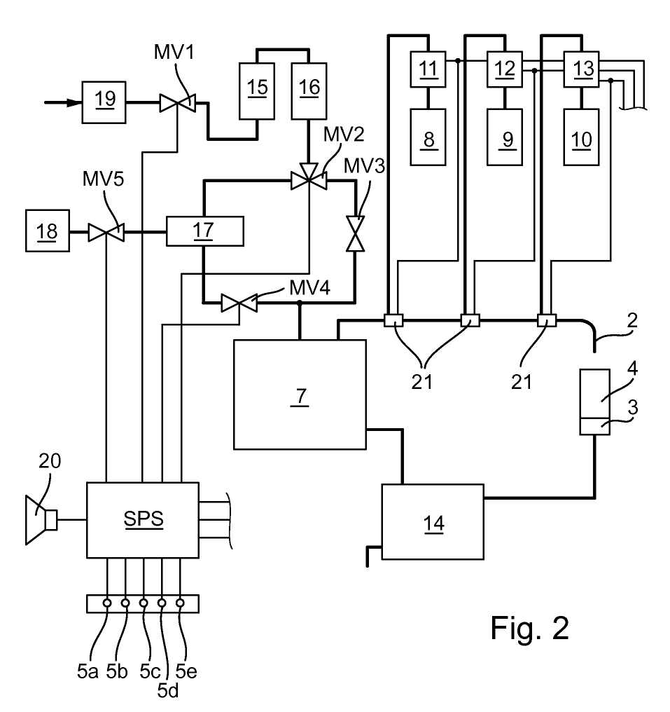

In addition, in a schematic view, FIG. 1 shows the arrangement of the individual components in the housing 6 of the device; for the sake of clarity, the connecting lines and the control devices as well as valves described in conjunction with FIG. 2 are not shown. The housing 6 has a support frame 7 on which an electrolysis unit 7 producing a reduced ionized basic water with a pH value ranging from 8 to more than 9 (depending on the source water) is installed in a central location. Above the electrolysis unit 7, there are three containers 8, 9, 10 that contain the probiotic fluid, the liquid minerals, and the liquid trace elements. By means of appropriate hose pumps 11, 12, 13, the fluids are added to the reduced ionized basic water exiting from the electrolysis unit 7 via check valves or mini magnetic valves 21. The acidic waste water exiting from the electrolysis unit 7, as well as the water reaching the drinking container holder 3 are collected in a waste water container 14 and disposed of by means of an immersion pump with float switch (not shown).

Below the electrolysis unit 7, there is the water inlet with two cartridge filters in series that clean the incoming tap water. The first cartridge filter 15 has an activated carbon filter and a microfilter while the second cartridge filter 16 has elements for the information of the water. In this area, there is also an oxygen enrichment unit 17 that receives the medical oxygen from an oxygen bottle 18 located above the electrolysis unit 7. In principle, an oxygen concentration device may be used instead. The oxygen enrichment unit 17 comprises an enrichment chamber 22 with hollow fibers oriented in a longitudinal direction through which the water flows and then exits from the enrichment chamber 17 (described in EP 1 481 720, for example); at a right angle to the flow direction of the water, the oxygen bottle 18 is connected to the enrichment chamber 8 so that the gas passes through the walls of the hollow fibers into the water they contain. All consumables in this upper section are easily accessible for replacement purposes.

Behind a wall and shown by dotted lines, the housing 6 also contains a programmable control unit (SPS) for controlling the individual units for dispensing the enriched water. The control unit also includes a voice module. Dosing of the individual fluids is accomplished by means of a timer control. Also shown by dotted lines, a loudspeaker 20 for voice commands to the user is located behind a wall.

FIG. 2 shows schematically the wiring diagram that is used below to explain the interaction of the individual components. The water lines are shown thicker than the electric lines.

The incoming tap water arrives at a pressure reducer 19 which sets the working pressure for the entire system to 1 l/min. This is followed by a magnetic valve MV1 that is connected with the control unit SPS. The control unit SPS is connected with additional magnetic valves MV2, MV4, and MV5, the loudspeaker 20 for voice output, and the selector keys 5a to 5e, shown schematically as one block. Behind the magnetic valve MV1 follow the cartridge filters 15 and 16, connected in series, as well as the magnetic valve MV2 as a 2×2-way valve. In normal condition, this magnetic valve closes the path to the oxygen enrichment unit 17 so that normally the water reaches the electrolysis unit 7 via the branch followed by the magnetic valve MV3. On the outlet side, the oxygen enrichment unit 17 is also connected with the electrolysis unit 7 via the magnetic valve MV4. The magnetic valve MV5 that is also connected with the control unit SPS, like the magnetic valves MV2 and MV4, is located between the oxygen bottle 18 and the oxygen enrichment unit 17. As a result of the placement and the controlled opening of the magnetic valves MV2, MV4, and MV5, oxygen is introduced into this area from the oxygen bottle 18, depending on the bottle pressure, while, at the same time, the water located there is fed to the electrolysis unit 7 under timer control for a cup volume of 400 ml, for example. When this time expires, the valves are closed again.

The oxygen introduced into this area during the timed flow is preserved and surrounds the hollow fibers in the enrichment chamber. In this oxygen atmosphere, the water that reaches the area surrounding the hollow fibers even while standing still, is enriched with oxygen.

The magnetic valve MV3 serves merely for pressure reduction in order to adjust the resistance to the path going through the oxygen enrichment unit 17. Via the outlet 28 for the acidic water, the electrolysis unit 7 is connected with a waste water container whose outlet disposes of the water in a suitable drain. This is accomplished, for example, by means of an immersion pump with a float switch and a waste water hose that drains into the waste pipe of the building. The control unit SPS is also connected with the hose pumps 11, 12, 13 that, when needed, pump the fluid under timer control for a pre-selected period from the containers 8 for the probiotic beverage, 9 for the liquid minerals, and 10 for the liquid trace elements, adding it via magnetic valves 21 to the reduced ionized basic water exiting from the electrolysis unit 7 via the outlet 29 so that the enriched drinking water can be dispensed via the drinking water outlet 2. The fill level of the containers 8, 9, 10 and of the oxygen bottle 18 is measured and displayed (not shown). The components shown in the implementation may be replaced by other suitable ones.

As mentioned above, the dosing of the fluid quantities is subject to timer control. The pressure reducer sets the flow rate at 1 l/min, and the timer control is based on this information. After actuating the selector keys 5a, 5b, 5c, 5d, 5e, the magnetic valve MV1 (2×2 way) is opened so that the water reaches the electrolysis unit 7 directly. This unit is connected to line power, and switches on automatically when there is any water pressure present. After a rinsing process for cleaning the electrodes, the electrolysis unit automatically switches to the production of basic water. In front of the drinking container holder 3, the water produced during this period flows into the waste water container 14. After a build-up period of at least 20 seconds, during a brief stop of the water flow, the user is asked to place his drinking container 4 on the drinking container holder 3, and to select an additive if desired. Then, the drinking container is filled. If the user desires additives, he/she pushes the appropriate keys 5b to 5d. Depending on the user's selection, the appropriate hose pump 11, 12, or 13 is activated by the control unit SPS. If the user desires oxygenated water, pushing the appropriate key (here 5e, for example) triggers the opening of the magnetic valves MV4 and MV5 and switches over the magnetic valve MV2.

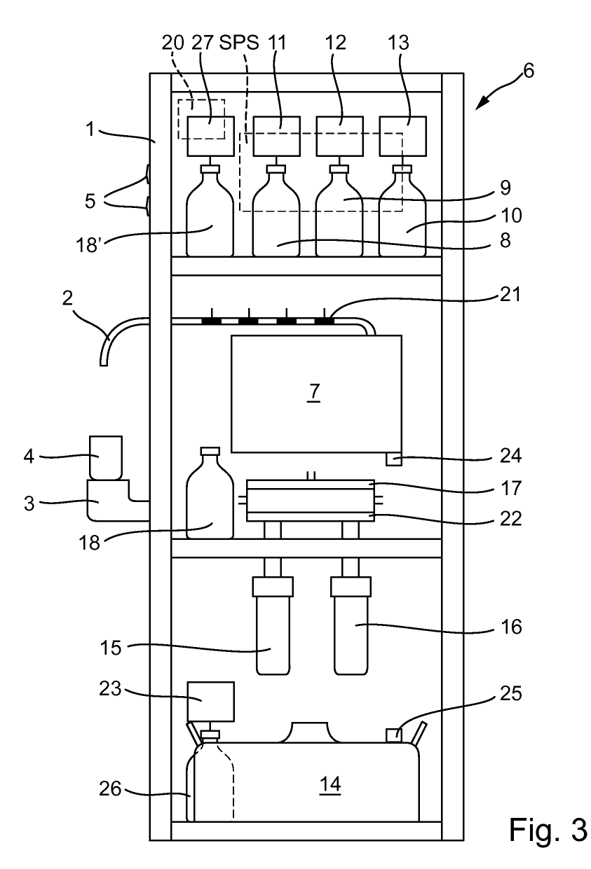

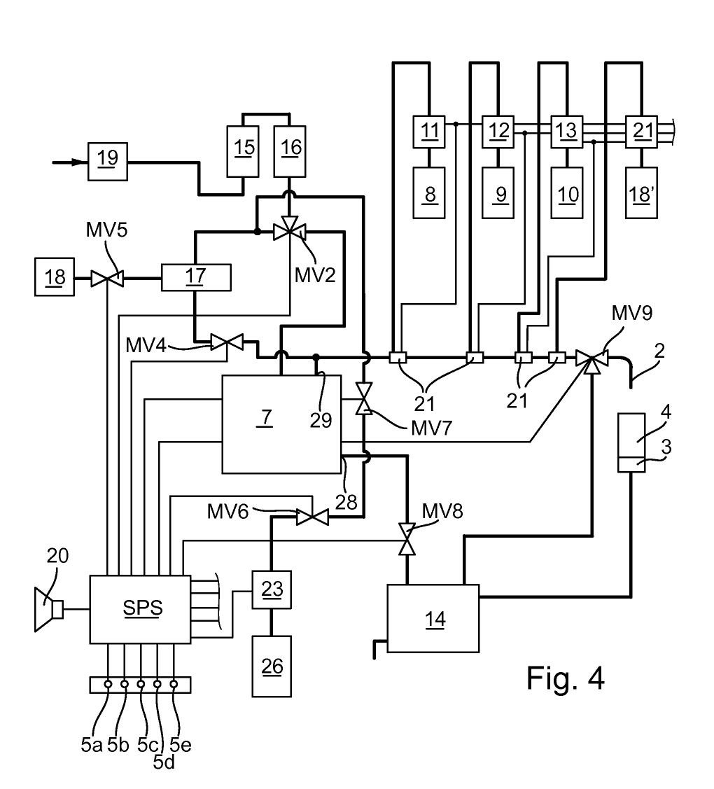

In the implementation shown in FIG. 3 and 4, components corresponding to identical ones in FIGS. 1 and 2 are given the same reference symbols. Similarly, like FIG. 1, the schematic drawing in FIG. 3 does not show any connecting lines, control devices, and valves that are described in conjunction with FIG. 4.

In FIG. 3, an additional container 18′ is provided, containing stabilized oxygen that can be dosed like the other additives by means of the immersion pump 27. In addition, there is a container 26 with 30% citric acid that is fed into the electrolysis unit for cleaning purposes after a certain number of fillings by means of an appropriate hose pump 23 and is controlled by the control unit SPS (FIG. 4). The permissible number of fillings depends on the quality of the source water. In FIG. 3, the number 24 indicates a connection for acidic water and number 25 indicates the corresponding connection with the waste water container 14. The container 18′ for stabilized oxygen is located next to the other containers 19 and 11 for the additives. In this implementation, the gas bottle 18 with the gaseous oxygen is located close to the electrolysis unit 7.

FIG. 4 shows the wiring diagram with the water lines shown thicker than the electric lines. The arriving tap water reaches a pressure reducer 19 that sets the working pressure for the entire system to 1 liter per minute. This is followed by the cartridge filters 15 and 16 that are connected in series. The filtered water then reaches the 2×2 way valve MV2. All electric valves shown in the implementations are magnetic valves. All valves are controlled electrically by the control unit SPS. The magnetic valves are energized by the control unit SPS depending on the selection made with the keys 5a to 5f. After the magnetic valve MV2, the water reaches the oxygen enrichment unit. In conjunction with the implementation shown in FIG. 2, the enrichment may be accomplished in the enrichment chamber 17 by means of the gaseous oxygen from the oxygen bottle 18. For this purpose, the magnetic valves MV4 and or MV7 are actuated appropriately so that the water can flow through this branch. As soon as the selected quantity has passed through, the magnetic valve MV4 is closed first and, after a certain period, also the valve MV5 so that the oxygen can diffuse without pressure into the water in the enrichment chamber 17. Parallel to this, liquid oxygen can be added to the water from the container 18′ by means of a mini magnetic valve 21 and via the immersion pump 27. As can be seen from the figure, it is possible to add both types of oxygen, or only one. Via the 3×2 way valve MV9 that is closed when de-energized, the oxygen-enriched water passes into the container 4. The other branch of the valve MV2 leads to the inlet of the electrolysis chamber 7 that [produces] basic water leaving the electrolysis unit 7 through the outlet 29, and acidic water leaving the electrolysis chamber through the outlet 28. Via MV8 that is open when de-energized, the acidic water passes into the waste water container 14. The reduced ionized water exiting from the outlet 29 of the electrolysis unit 7 can be dispensed, as described in conjunction with FIG. 2, with the fluids in the containers 8, 9, 10 via the drinking water outlet 2 by opening the valve MV9. The 3×2 way valve MV9 connects the line leading to the drinking water outlet 2 with the waste water container 14 in order to drain the water collected during the build-up time of at least 20 seconds.

Compared with the implementation according to FIG. 2, the implementation according to FIG. 4 contains an additional cleaning device specifically for counteracting calcium deposits in and a hygienization of the electrolysis unit 7. For this purpose, a container 26 holds 30% citric acid concentrate that is fed together with filtered water into the outlet 28 of the electrolysis unit 7 by means of the hose pump 23. For this purpose, the two magnetic valves MV6 and MV7 are opened, and the magnetic valve MV8 is closed. After a specified quantity of citric acid concentrate+water has been added to the electrolysis unit 7, the process is terminated. The introduction of citric acid solution is an automatic process after a certain number of fillings, or after a specified period, and is preferably done at night to give the citric acid solution time to act. After a specified period, the electrolysis unit 7 is rinsed for a certain length of time via the magnetic valve MV7 and with the magnetic valve MV8 still closed. After that, the magnetic valve MV8 is also opened again. During the calcium removal, the control unit SPS deactivates all other functions, including the electrolysis unit.

As described above in conjunction with the implementation according to FIG. 2, the control of the fluid quantities and therefore the opening or closing of the valves in question is based on timer control. With the exception of the differences discussed above, the functional principles of the implementations are the same.

The device and the process proposed by the invention make it possible to provide drinking water treated in five different ways in a simple manner. Of course, the treatment for each type of drinking water may be accomplished with a separate device, but, regarding the electrolysis unit, this would appear appropriate only in special applications. As shown in this implementation, it is much more economical to make multiple use of the commercial electrolysis unit 7 for various enriched beverages with special electrochemical properties that have a health-promoting effect on the human body.

1. A device for providing at least one treated drinking water for dispensing into a container, with a housing for holding a water treatment device, an operating unit, a control unit, and a drinking water dispenser, wherein the water treatment device comprises an electrolysis unit that separates water supplied under pressure into anions and cations and produces an acidic and a basic water, and that the control unit does not release the basic water to the user until after a build-up time of at least 20 seconds.

2. A device according to claim 1, wherein the water treatment device includes a oxygen enrichment unit that is connected with the electrolysis unit and feeds it with oxygen-enriched water.

3. A device according to claim 2, wherein the oxygen enrichment unit has an enrichment chamber where standing water is surrounded by oxygen without pressure.

4. A device according to claim 1, wherein the water treatment device includes devices for adding liquid additives to the released drinking water.

5. A device according to claim 4, wherein the devices for adding liquid additives comprise a device for adding a probiotic fluid and/or a device for adding liquid minerals and/or a device for adding liquid essential trace elements.

6. A device according to claim 1, wherein a voice unit is provided for giving instructions and information to the user.

7. A device according to claim 1, wherein a cleaning and hygienization device is provided, in particular for the electrolysis unit.

8. A process for the treatment of drinking water that uses a water treatment device and a control unit, where tap water is fed into the water treatment device and ionized acidic or ionized basic water is produced by means of an electrolysis unit, and where the produced basic water is released for dispensing into a container by the control unit after a build-up time of at least 20 seconds.

9. A process according to claim 8, wherein oxygen-enriched water is fed into the electrolysis unit.

10. A process according to claim 9, wherein the oxygen enters the water without pressure.

11. A process according to claim 8, wherein a probiotic fluid, liquid minerals, or liquid trace elements are injected into the basic water in the stream of water flowing to the container.

12. A process according to claim 8, wherein the electrolysis unit is cleaned automatically after a certain number of dispensing processes by means of a cleaning agent, preferably citric acid.
